(19) United States
(12) Patent Application Publication
(10) Pub. No.: US 2004/0131242 A1
(43) Pub. Date: Jul. 8, 2004

(54) Monitoring method

(76) Inventor: Valery Alekseevich Klevtsov, Novosibirsk (RU)

Correspondence Address: Oliff & Berridge, PO Box 19928, Alexandria, VA, 22320, US

(21) Appl. No.: 10/472,509

(22) PCT Filed: Mar. 19, 2002
(86) PCT No.: PCT/GB02/01312

(30) Foreign Application Priority Data
Mar. 19, 2001 (GB) 0106817.0

(51) Int. Cl. G06K 9/00

(52) U.S. Cl. 382/137; 382/181

(57) ABSTRACT

A method of monitoring markings (11) made on printed documents (1) comprises obtaining a digital representation of a face of a document by determining single or multiple colour component content of pixels of the representation; comparing (8,9) the colour component content of each pixel of the representation with a range extending between upper and lower thresholds for the corresponding pixel of an acceptable unmarked document and generating a corresponding anomaly pixel (10) if the pixel value falls outside the range; and determining (21-24) the presence of a marking (11) if the resulting anomaly pixels satisfy predetermined conditions.

The invention relates to a method of monitoring documents and in particular monitoring markings made on printed documents.

In a number of applications, there is a need to be able to detect markings such as graffiti made on previously printed documents such as documents of value including banknotes and the like. This should be distinguished from detecting the soil condition of documents since soiling is typically at a substantially constant level across the document whereas the markings with which this invention are concerned include lines, regions of defacement such as ink stains and the like.

EP-A-0165734 discloses a method for comparing an incoming banknote with a master pattern so as to take account of variations in the appearance of a particular pixel. It should be noted, however, that this is concerned with the inspection of documents (or objects) that have not been in circulation.

U.S. Pat. No. 6,012,565 discloses the classification of documents but is not concerned with detection of markings on documents.

WO-A-00/26861 is concerned with a currency recognition process and also considers soil detection. However, as explained above, soil detectors are not able to detect markings such as graffiti.

In accordance with the present invention, a method of monitoring markings made on printed documents comprises obtaining a digital representation of a face of a document by determining single or multiple colour component content of pixels of the representation; comparing the colour component content of each pixel of the representation with a range extending between upper and lower thresholds for the corresponding pixel of an acceptable unmarked document and generating a corresponding anomaly pixel if the pixel value falls outside the range; and determining the presence of a marking if the resulting anomaly pixels satisfy predetermined conditions.

The invention enables markings such as graffiti to be detected and allows the degree of graffiti to be determined. This provides the user with the ability to be more (or less) tolerant of a particular form of defacement.

Typically, a single colour component or grey level value will be determined for each pixel but in more sophisticated examples a multi-colour component representation of each pixel could be obtained.

The upper and lower thresholds can be obtained by a variety of techniques. For example, one or more unmarked documents could be examined and an average value determined for each pixel. This average value could then be modified by adding a suitable value or by multiplying by a suitable value to obtain the upper and lower thresholds. Alternatively, a variety of unmarked documents, used and unused, could be analysed and-a record kept of the least bright and brightest values for each pixel which can then be used to constitute the lower and upper thresholds.

In the preferred approach, the images of a representative sample of the population of the banknotes in circulation are captured; these must exhibit no defacement. Within that population, the darkest pixels in each x,y position are found and are used to make up the lower surface image. A similar process using the lightest pixels is employed to generate the upper surface image.

These stored values could then be further modified using multiplicative or additive coefficients to generate final upper and lower thresholds prior to comparison with the input pixel values.

Once the anomaly pixels have been identified, the method then seeks to determine whether or not one or more predetermined conditions are satisfied. These predetermined conditions can be selected from:

a) the total number of anomaly pixels being greater than a “gross” threshold;

b) the total number of anomaly pixels within a marking having a perimeter to area ratio greater than a first predetermined parameter being greater than a “sparse” threshold;

c) the total number of anomaly pixels within a marking having a perimeter to area ratio less than a second predetermined parameter being greater than a “compact” threshold; and

d) the total number of anomaly pixels within a specified distance of another anomaly pixel being greater than a “group” threshold.

Typically, each of these conditions will be determined and more than one may indicate a positive result thus indicating the type of graffiti or other markings present on the document. The user canhen decide whether the level of markings is acceptable allowing, in the case of banknotes, the banknotes to be recirculated, or unacceptable in which case the banknotes should be withdrawn from circulation.

Although typically the representations will be those which can be seen under visible illumination, they could include instead or in addition representations visible under normally non-visible irradiation such as ultraviolet or infrared.

The invention is applicable to a wide variety of processes including document sorting, counting, dispensing, validating and recirculating. It can be used for processing a variety of documents, including security documents and documents of value such as banknotes.

The invention can be implemented using conventional pattern recognition hardware and is particularly suitable for use in the De La Rue Vision™ system.

An example of a method according to the invention will now be described with reference to the accompanying drawings, in which:

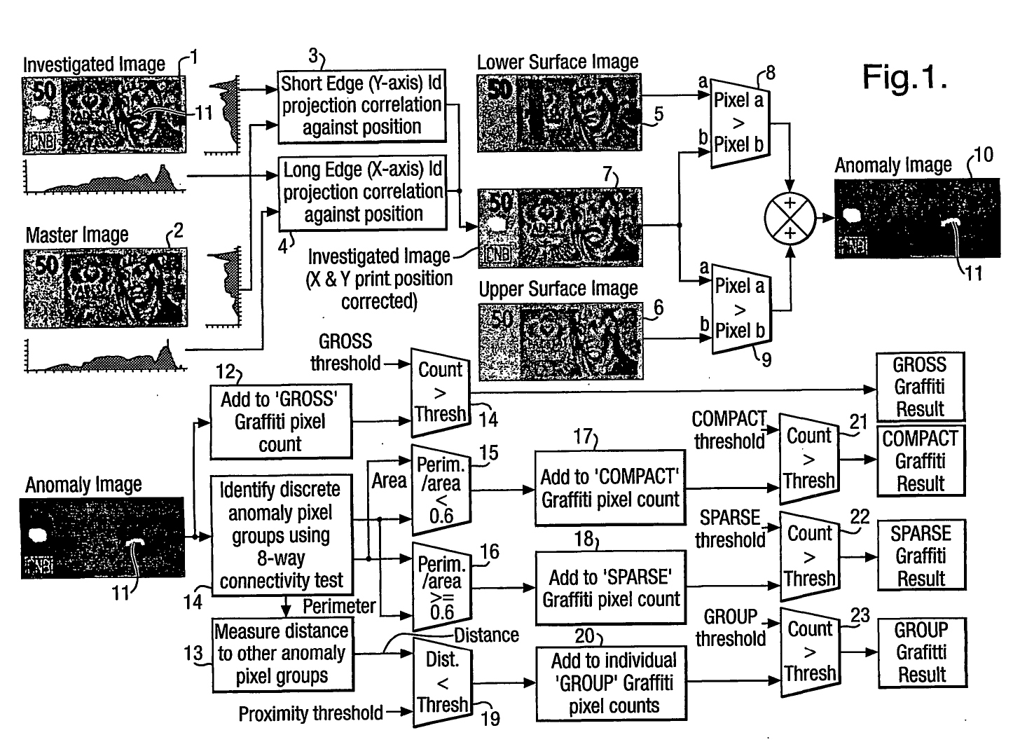

FIG. 1 is a flow diagram of the method;

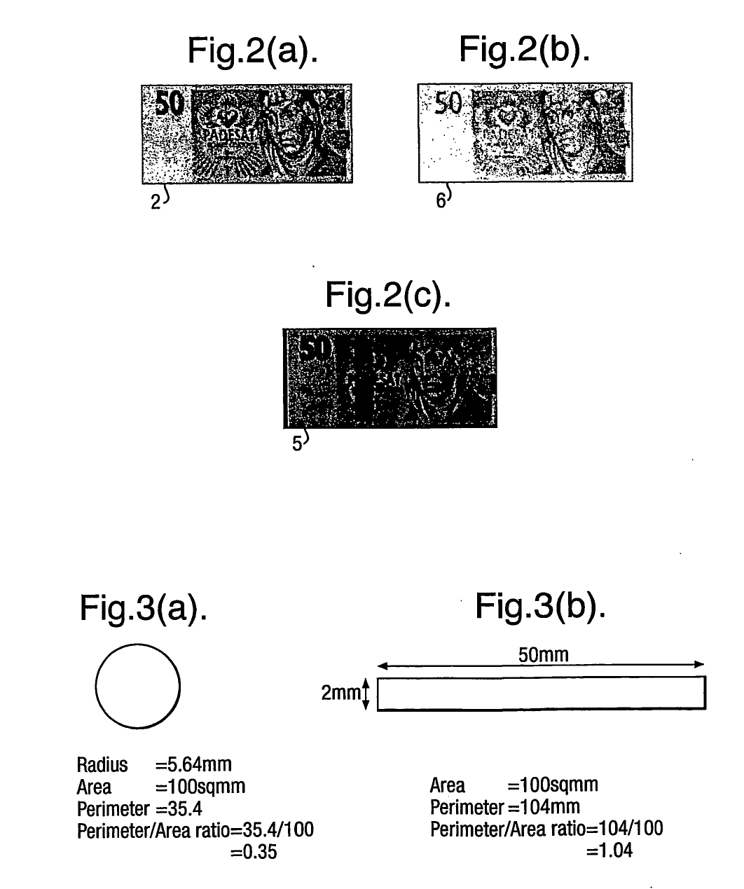

FIGS. 2A-2C illustrate an image of a good quality banknote, an image of the banknote with each pixel having its highest value, and an image of the same banknote with each pixel having its lowest value respectively; and,

FIGS. 3A and 3B illustrate examples of a compact pixel and a sparse pixel respectively.

FIG. 1 illustrates an image of a banknote under test at 1 and a corresponding master image 2 of the same banknote which will be stored in memory. In many cases, more than one master image will be stored, for example corresponding to the same banknote in different orientations and also to banknotes of different denominations. In order to be able to carry out the method, it is first necessary to correlate the investigated image 1 with its corresponding master image 2. This can be achieved in a variety of ways once the investigated image 1 has been digitized and for example is conveniently achieved by comparing the location of known printed features on the two images. This is achieved by producing one-dimensional “projections” of mean column/row pixel intensity in the direction of the long and short edges of the note (steps 3,4). These are then correlated with corresponding master image projections at incremental positions around the origin. The position yielding the highest correlation score is judged to be the correct position. This positional offset measurement is added to the investigated image 1 when comparing with the surface images in the succeeding steps.

For each master image 2, the system stores a corresponding lower surface image 5 and an upper surface image 6. These are shown in more detail in FIGS. 2C and 2B respectively with an image of a good quality note, corresponding to the master image 2, shown in FIG. 2A.

The content of each pixel of the upper surface image 6 has been obtained by reviewing a large number of genuine notes and recording the brightest value of each pixel in the group of notes. Similarly, the lower surface image 5 is obtained by recording the least bright or lowest value in the group for each pixel.

The position corrected version of the investigated image 7 is then compared, pixel by pixel, with the lower and upper surface images 5,6. If the amplitude of the pixel with position (x₁,y₁) in the investigated image is greater than the amplitude of the corresponding pixel with position (X₁,y₁) in the upper surface image then this pixel is classed as an anomaly pixel, causing the pixel with position (x₁,y₁) in an anomaly image 10 to become set. The same test is applied to the investigated and lower surface images, i.e. if investigated image pixel amplitude <lower surface image pixel amplitude then set anomaly pixel.

The result of this process is the generation of an “anomaly image” 10 where it can be seen that a marking 11 on the investigated image 1 has been identified. However, in order for the process to detect the marking, a further analysis of the anomaly image 10 is required. In this process, each anomaly pixel is reviewed and categorised. The method thus scans the anomaly image pixel-by-pixel. When it reaches an anomaly pixel, a “gross” graffiti pixel count is incremented (step 12).

In a step 14, groups of anomaly pixels are reviewed using an 8-way connectivity test to determine their area and perimeter, i.e. the anomaly pixel under examination (centre pixel in a 3×3 grid) is directly bordered by another anomaly pixel (one or more of the 8 outlying pixels in the same 3×3 grid). This enables the pixels within these groups to be characterized as either “sparse” or “compact” depending upon the ratio between the perimeter and the area of the group. FIG. 3A illustrates a typical example of a group of pixels classified as compact (perimeter/area ratio=0.35) and FIG. 3B an example of the group of pixels classified as sparse (perimeter/area ratio=1.04). This classification is achieved by feeding the area and perimeter information to comparators 15,16 where the ratio is compared with a parameter, in this case 0.6. The parameters need not be the same. Depending upon the outcome of these comparisons, an appropriate one of a compact count 17 and a sparse count 18 is incremented.

Following determination (step 13) of the distance between an anomaly pixel and another anomaly pixel, this distance is compared with a proximity threshold in a step 19 and if the distance is less than the proximity threshold the group count is incremented (step 20).

The counts determined in steps 17,18,20 are then compared with respective thresholds in steps 21-23 respectively to yield final results along with the result of comparing the gross count with a threshold (step 24).

These results can then simply be stored and/or displayed and/or utilized by the machine carrying out the analysis to direct the manner in which the note is to handled. For example, notes which indicate an unacceptable level of graffiti could be diverted to a cull station or cause the machine to stop.

The “compact” count exceeding a threshold will indicate the presence of a stain or other “solid” defacement, the “sparse” count exceeding a threshold will indicate the presence of handwriting or drawing, and the “group” count exceeding a threshold will indicate coordinated defacement such as a bank's ink stamp.

The invention can, of course, be implemented in software, hardware or firmware as will be apparent to a person of ordinary skill in the art.

1. A method of monitoring markings made on printed documents, the method comprising obtaining a digital representation of a face of a document by determining single or multiple colour component content of pixels of the representation; comparing the colour component content of each pixel of the representation with a range extending between upper and lower thresholds for the corresponding pixel of an acceptable unmarked document and generating a corresponding anomaly pixel if the pixel value falls outside the range; and determining the presence of a marking if the resulting anomaly pixels satisfy predetermined conditions, wherein a number of unmarked documents are analysed, the least bright and brightest values for each pixel being used directly or following modification to constitute the lower and upper thresholds respectively.

2. A method according to claim 1, wherein the upper and lower thresholds are obtained by defining a range about an average value for each pixel.

3. A method according to any of the preceding claims, wherein the predetermined conditions are selected from one or more of:
a) the total number of anomaly pixels being greater than a “gross” threshold;
b) the total number of anomaly pixels within a marking having a perimeter to area ratio greater than a first predetermined parameter being greater than a “sparse” threshold;
c) the total number of anomaly pixels within a marking having a perimeter to area ratio less than a second predetermined parameter being greater than a “compact” threshold; and
d) the total number of anomaly pixels within a specified distance of another anomaly pixel being greater than a “group” threshold.

4. A method according to any of the preceding claims, wherein the digital representation of a face of a document corresponds to the appearance of that face under visible illumination.

5. A method according to any of the preceding claims, wherein the document comprises a security document or document of value, such as a banknote.
